(19) United States
(12) Patent Application Publication
(10) Pub. No.: US 2026/0014625 A1
(43) Pub. Date: Jan. 15, 2026

(54) METHODS FOR REMOVING A CONDUCTIVE STRUCTURE FROM A SUBSTRATE

(71) Applicant: XTPL S.A., Wroclaw (PL)

(72) Inventors: Aneta Wiatrowska, Wroclaw (PL); Aleksandra Chudzynska, Wroclaw (PL); Witold Nawrot, Zurawiniec (PL); Mateusz Lysien, Zywiec (PL); Piotr Kowalczewski, Lódz (PL)

(73) Assignee: XTPL S.A., Wroclaw (PL)

(21) Appl. No.: 19/263,740

(22) Filed: Jul. 9, 2025

Related U.S. Application Data
(60) Provisional application No. 63/669,824, filed on Jul. 11, 2024.

(51) Int. Cl. B22F 10/62; B22F 10/66; B33Y 40/20

(52) U.S. Cl. CPC B22F 10/62; B22F 10/66; B33Y 40/20

(57) ABSTRACT

Methods for removing a conductive structure from a substrate are provided. The method includes additively manufacturing a conductive structure on a substrate. The method includes sintering the conductive structure and performing a manufacturing process with the conductive structure. The method includes removing the conductive structure from the substrate.

### CROSS REFERENCE TO RELATED APPLICATIONS

This application claims priority to U.S. Provisional Patent Application No. 63/669,824, which was filed on Jul. 11, 2024. The entire contents of which is hereby incorporated by reference into this specification.

### BACKGROUND

There are challenges with creating microscale electrical connections on surfaces of a PCB, silicon-based electronic components, flexible substrates, and other substrates that are the basis of microelectronic devices.

### SUMMARY

The present disclosure provides a method including additively manufacturing a conductive structure on a substrate. The method includes sintering the conductive structure and performing a manufacturing process with the conductive structure. The method includes removing the conductive structure from the substrate.

The present disclosure also provides a method for removing a conductive structure from a substrate. The method includes contacting the conductive structure with a solution. The solution is at a temperature in a range of 10° C. to 120° C. for a time period in a range of 1 minute to 24 hours.

It is understood that the present disclosure is not limited to the examples summarized in this Summary. Various other aspects are described and exemplified herein.

### BRIEF DESCRIPTION OF THE DRAWINGS

The features and advantages of the examples, and the manner of attaining them, will become more apparent, and the examples will be better understood, by reference to the following description taken in conjunction with the accompanying drawings, wherein:

FIG. 1A is an image of additive manufactured conductive structures on a copper substrate prior to a removal procedure and the additive manufactured conductive structures include a serpentine line and a solid pad;

FIG. 1B is an image of the copper substrate of FIG. 1A after a removal procedure including contacting the conductive structures with a solution at a temperature of 100° C. for a time period of 30 minutes and ultrasonic vibrations for a time period of 15 minutes at a temperature of 55° C.;

FIG. 2A is an image of additive manufactured conductive structures on a polymeric substrate (e.g., polyimide) prior to a removal procedure and the additive manufactured conductive structures include a serpentine line and a solid pad;

FIG. 2B is an image of the polymeric substrate of FIG. 2A after a removal procedure including contacting the conductive structures with a solution at a temperature of 100° C. for a time period of 30 minutes and ultrasonic vibrations for a time period of 15 minutes at a temperature of 55° C.;

FIG. 3A is an image of additive manufactured conductive structures on a polymeric substrate prior to a removal procedure and the additive manufactured conductive structures include a serpentine line and a mesh pad;

FIG. 3B is an image after a removal procedure including contacting the conductive structures with a solution at a temperature of 100° C. for a time period of 30 minutes and ultrasonic vibrations for a time period of 15 minutes at a temperature of 55° C.;

FIG. 3C is a magnified view of a portion of FIG. 3B;

FIG. 4A is a schematic representation of additive manufactured conductive structures on a polymeric substrate prior to a removal procedure and the additive manufactured conductive structures include a serpentine line and a mesh pad;

FIG. 4B is an image after a removal procedure including contacting the conductive structures with a solution at a temperature of 100° C. for a time period of 30 minutes and ultrasonic vibrations for a time period of 15 minutes at a temperature of 55° C.;

FIG. 4C is a magnified view of a portion of FIG. 4B;

FIG. 5A is an image of an additive manufactured conductive structure on a substrate prior to a removal procedure;

FIG. 5B is an image of an additive manufactured conductive structure on a substrate prior to a removal procedure;

FIG. 5C is an image of an additive manufactured conductive structure on a substrate prior to a removal procedure;

FIG. 5D is an image of an additive manufactured conductive structure on a substrate after a removal procedure;

FIG. 5E is an image of an additive manufactured conductive structure on a substrate after a removal procedure;

FIG. 5F is an image of an additive manufactured conductive structure on a substrate after a removal procedure;

FIG. 6A is an image of additive manufactured conductive structures on a substrate prior to a removal procedure;

FIG. 6B is an image of additive manufactured conductive structures on a substrate after a removal procedure; and

FIG. 7 is a flow chart illustrating a method of removing conductive structure from a substrate according to the present disclosure.

Corresponding reference characters indicate corresponding parts throughout the several views. The exemplifications set out herein illustrate certain embodiments, in one form, and such exemplifications are not to be construed as limiting the scope of the appended claims in any manner.

### DETAILED DESCRIPTION

Certain exemplary aspects of the present disclosure will now be described to provide an overall understanding of the principles of the structure, function, manufacture, and use of the compositions, methods, and products disclosed herein. One or more examples of these aspects are illustrated in the accompanying drawings. Those of ordinary skill in the art will understand that the devices and methods specifically described herein and illustrated in the accompanying drawings are non-limiting exemplary aspects and that the scope of the various examples of the present disclosure is defined solely by the claims. The features illustrated or described in connection with one exemplary aspect may be combined with the features of other aspects. Such modifications and variations are intended to be included within the scope of the present disclosure.

Any references herein to “various examples,” “some examples,” “one example,” “an example,” similar references to “aspects,” or the like, means that a particular feature, structure, or characteristic described in connection with the example is included in at least one example. Thus, appearances of the phrases “in various examples,” “in some examples,” “in one example,” “in an example,” similar references to “aspects,” or the like, in places throughout the specification are not necessarily all referring to the same example. Furthermore, the particular features, structures, or characteristics may be combined in any suitable manner in one or more examples. Thus, the particular features, structures, or characteristics illustrated or described in connection with one example may be combined, in whole or in part, with the features, structures, or characteristics of one or more other examples without limitation. Such modifications and variations are intended to be included within the scope of the present examples.

Additively manufacturing processes can result in structures that are affixed to a substrate long term. Additionally, if the additive manufactures structures are removed, a residue may remain upon the substrate following the removal. Accordingly, the present disclosure provides an additive manufacturing process that includes methods for removing a conductive structure from a substrate, which can enable more temporary additive manufacturing processes.

As used herein, “conductive structure” refers to an electrically conductive structure.

The present disclosure provides methods for removal of a conductive structure from a substrate. Prior to removing the conductive structure, the conductive structure can be additively printed on a substrate. For example, an ink composition can be printed by an additive manufacturing system.

An additive manufacturing system to print an ink composition herein can be similar to the fluid printing apparatus described in International Patent Application Publication No. WO 2020/157547, titled FLUID PRINTING APPARATUS, published Aug. 6, 2020, which is herein incorporated by reference in its entirety, although not limited thereto. An ink composition according to the present disclosure can comprise a metallic nanoparticle composition suitable for additive manufacturing, such as those described in U.S. Pat. No. 11,549,026 and U.S. patent application Ser. No. 17/425,660, which are hereby incorporated by reference, although not limited thereto.

In various examples, the ink composition can comprise various conductive components, such as, for example, a metal, a metal alloy, a conductive carbon, or a combination thereof. For example, the ink composition can comprise metal nanoparticles, such as, for example, copper (e.g., elemental, an alloy, a compound) nanoparticles, gold (e.g., elemental, an alloy, a compound) nanoparticles, silver (e.g., elemental, an alloy, a compound) nanoparticles, or a combination thereof. The metal nanoparticles can have a mean average particle size of no greater than 500 nanometers, as measured with transmission electron microscopy, such as, for example no greater than 150 nanometers or no greater than 100 nanometers. The metal nanoparticles can comprise a metal bound to a polymer, such as, for example, polyvinylpyrrolidone, acrylate, or a combination thereof.

The ink composition can comprise other components, such as, for example, a solvent (e.g., a polar protic solvent), a resin, or other compound. For example, the ink composition can comprise nanoparticles and a solvent. The ink composition can comprise at least 40% by weight nanoparticles based on the total weight of the ink composition, such as, for example, at least 50% by weight or at least 60% by weight nanoparticles all based on the total weight of the ink composition.

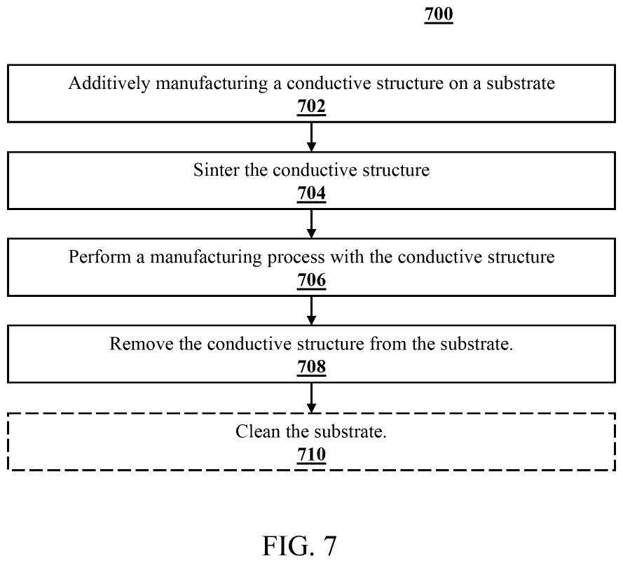

As illustrated in FIG. 7, a flow chart is provided illustrating a method 700 for removing a conductive structure from a substrate according to the present disclosure. The method 700 can comprise additively manufacturing a conductive structure on a substrate at step 702.

Additively manufacturing a conductive structure on a substrate can include disposing a nozzle of a cartridge assembly of an additive manufacturing system over a first location on the substrate; dispensing an ink composition from the nozzle onto the first location of the substrate, thereby forming a first portion of the structure on the first location; and repeating, as necessary, repositioning of the nozzle and dispensing ink composition from the nozzle, thereby forming the structure on the substrate.

Additively manufacturing can include applying a pressure in a range of 100 mbar to 10,000 mbar to the ink composition in the nozzle to extrude the ink composition through the nozzle and onto the substrate.

The additive manufactured conductive structures can be applied to the substrate by extruding an ink composition. The ink composition can comprise a viscosity in a range of 20 cP to 10,000,000 cP, such as, for example, 100,000 cP to 10,000,000 cP, 20 cP to 100,000 cP, 20 cP to 40,000 cP, 50 cP to 10,000,000 cP, 50 cP to 100,000 cP, 50 cP to 4,000 cP, 100 cP to 3,000 cP, or 200 cP to 1,200 cP, as measured at 25 degrees Celsius with a rheometer with a 25 mm parallel plate spindle and a shear rate in a range of 0.1 s⁻¹ to 100 s⁻¹.

The nozzle used to extrude the ink can include a capillary tube having an outer diameter in a range of 0.7 μm to 8 μm.

The structure can include a metal or a metal alloy. The metal can comprise silver or a silver alloy.

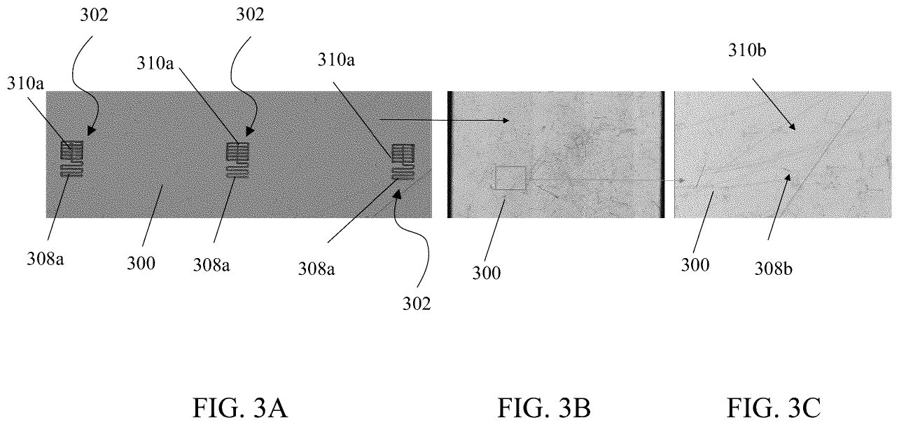

The structure can include a line, a solid pad, a mesh pad (e.g., a mesh pad as illustrated in FIG. 3), or a combination thereof.

The line can be a serpentine line. The line can have a width in a range of 0.1 μm to 50 μm.

The structure can include 1 to 10 layers, such as, for example, 1 to 5 layers.

The structure can have a thickness in a range of 0.1 μm to 20 μm, such as, for example, 0.1 μm to 5 μm.

The substrate can include a metal, a metal alloy, a polymer, or a combination thereof.

For example, the substrate can include copper, a copper alloy, a polymer, or a combination thereof.

Referring back to FIG. 7, the method 700 comprises sintering the conductive structure at step 704. Sintering can include heating the structure at a temperature in a range of 20° C. to 250° C. such as, for example, 180° C. to 220° C., 100° C. to 150° C., or 80° C. to 120° C., for a time period in a range of 1 minute to 8 hours, such as, for example, 5 minutes to 1 hour.

Sintering 704 can occur in an inert atmosphere (e.g., under nitrogen).

The method 700 comprises performing a manufacturing process with the conductive structure at step 706. Performing a manufacturing process can include applying a mask to the substrate using the conductive structure, electrodeposition, electroplating using the conductive structure, or a combination thereof.

The method 700 comprises removing the conductive structure from the substrate at step 708. Removing the conductive structure from the substrate can include a wet method, laser ablation, applying a resin to the conductive structure and peeling the resin off, plasma treatment, or a combination thereof. In various examples, removing the conductive structure from the substrate can include not substantially etching the substrate 100, not substantially corroding the substrate, or a combination thereof.

The wet method can include contacting the conductive structure with a solution for a time period in a range of 1 minute to 24 hours, such as, for example, 10 minutes to 2 hours. The solution can be at a temperature in a range of 10° C. to 120° C., such as, for example, 90° C. to 110° C.

The solution can include a solvent, such as, for example, water, an alcohol, acetone, or a combination thereof.

The solution can include a salt. The salt can include a chloride salt, a bromide salt, or a combination thereof. In various examples, the salt can include sodium chloride.

The wet method can include applying ultrasonic vibrations to the conductive structure. Ultrasonic vibrations can be applied for a time period in a range of 1 minute to 24 hours, such as, for example, 5 minutes to 1 hour, at a temperature in a range of 10° C. to 120° C., such as, for example, 40° C. to 65° C.

The method 700 optionally can comprise cleaning the substrate at step 710. Cleaning can include washing the substrate with a solvent; drying the substrate with a gas; and/or wiping the substrate with a cloth.

The solvent for cleaning can include water, acetone, an alcohol, or a combination thereof.

The gas for cleaning can include nitrogen.

The cloth can be dust-free.

### EXAMPLES

The present disclosure will be more fully understood by reference to the following examples, which provide illustrative non-limiting aspects of the invention. It is understood that the invention described in this specification is not necessarily limited to the examples described in this section.

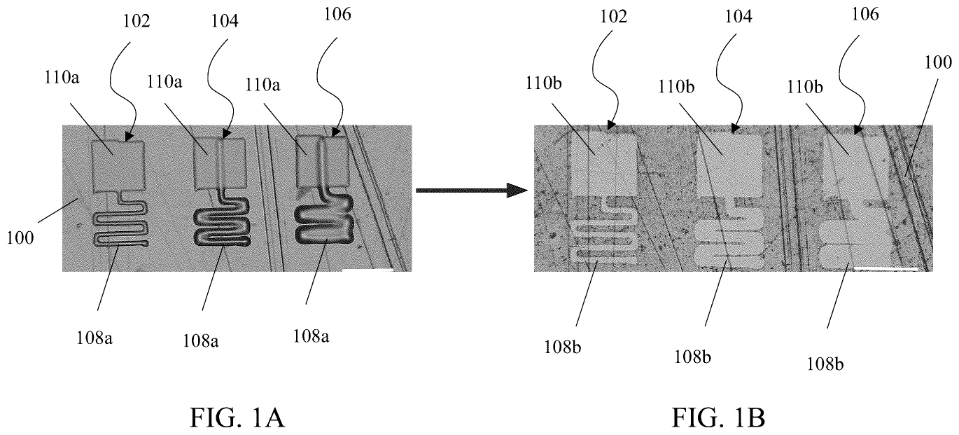

Referring to FIG. 1A, an image of additive manufactured conductive structures 102, 104, 106 on a copper substrate 100 before a removal procedure. Conductive structures 102, 104, 106 were additively manufactured onto a copper substrate 100. The process included additively manufacturing a one-layer additive manufacture structure 102, a three-layer additive manufacture structure 104, and a five-layer additive manufacture structure 106 onto the respective copper substrate 100. The structures 102, 104, 106 were additively manufactured to include two portions: a serpentine line 108a and a solid pad 110a.

Referring to FIG. 1B, the substrate 100 is shown following the removing procedure. The removal procedure used was a wet method of removal. The wet method included contacting the conductive structures with a solution at a temperature of 100° C. for a time period of 30 minutes. The wet method further included contacting the conductive structures with ultrasonic vibrations for a time period of 15 minutes at a temperature of 55° C. The process removed the additively manufactured structures 102, 104, 106, resulting in a removed serpentine line 108b and a removed solid pad 110b.

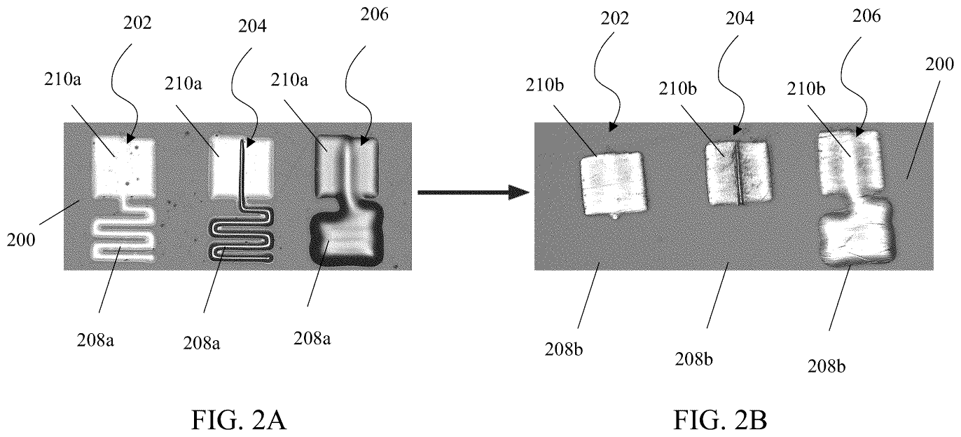

Referring to FIG. 2A, an image of additive manufactured conductive structures 202, 204, 206 on a polymeric substrate (e.g., polyimide) 200 before a removal procedure. Conductive structures 202, 204, 206 were additively manufactured onto the polyimide substrate 200. The process included additively manufacturing a one-layer additive manufacture structure 202, a three-layer additive manufacture structure 204, and a five-layer additive manufacture structure 206 onto the respective polyimide substrate 200. The structures 202, 204, 206 were additively manufactured to include two portions: a serpentine line 208a and a solid pad 210a.

Referring to FIG. 2B, the polyimide is shown following the removing procedure. The removal procedure used was a wet method of removal. The wet method included contacting the conductive structures with a solution at a temperature of 100° C. for a time period of 30 minutes. The wet method further included contacting the conductive structures with ultrasonic vibrations for a time period of 15 minutes at a temperature of 55° C. The process removed the additively manufactured structures 202, 204, 206 resulting in the removed serpentine line 208b and the removed solid pad 210b

Referring to FIG. 3A an image of a first sample of additive manufactured conductive structures 302 on a polyimide substrate 300 before a removal procedure. The structures 302 were additively manufactured to include a serpentine line 308a and a mesh pad 310a.

Referring to FIGS. 3B and 3C, the polyimide substrate 300 is shown following a removal and cleaning procedure. The removal procedure included contacting the conductive structures with a solution at a temperature of 100° C. for a time period of 30 minutes and ultrasonic vibrations for a time period of 15 minutes at a temperature of 55° C. Additionally, a cleaning step occurred to clean the substrate following removal of the structures 302. The cleaning step included washing the substrate with a solvent, drying the substrate with a gas, and wiping the substrate with a cloth.

FIG. 3B depicts the polyimide substrate 300 following the removal procedure and cleaning step showing the removed serpentine line 308b and the removed mesh pad 310b. FIG. 3C depicts a zoomed in portion of FIG. 3B.

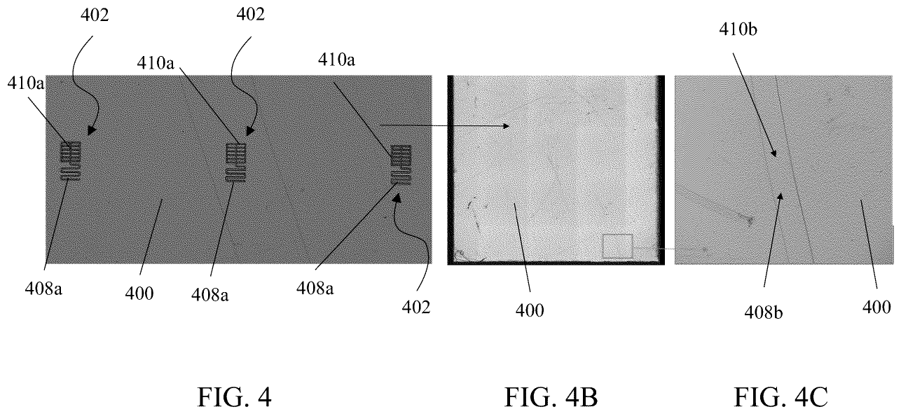

Referring to FIG. 4A an image of a second sample of additive manufactured conductive structures 402 on a polyimide substrate 400 before a removal procedure. The structures 402 were additively manufactured to include a serpentine line 408a and a mesh pad 410a.

Referring to FIGS. 4B and 4C, the polyimide substrate 402 is shown following a removal and cleaning procedure. The removal procedure included contacting the conductive structures with a solution at a temperature of 100° C. for a time period of 30 minutes and ultrasonic vibrations for a time period of 15 minutes at a temperature of 55° C. Additionally, a cleaning step occurred to clean the substrate following removal of the structure. The cleaning step included washing the substrate with a solvent, drying the substrate with a gas, and wiping the substrate with a cloth.

FIG. 4B depicts the polyimide substrate 400 following the removal procedure and cleaning step showing the removed serpentine line 408b and the removed mesh pad 410b. FIG. 4C depicts a zoomed in portion of FIG. 4B.

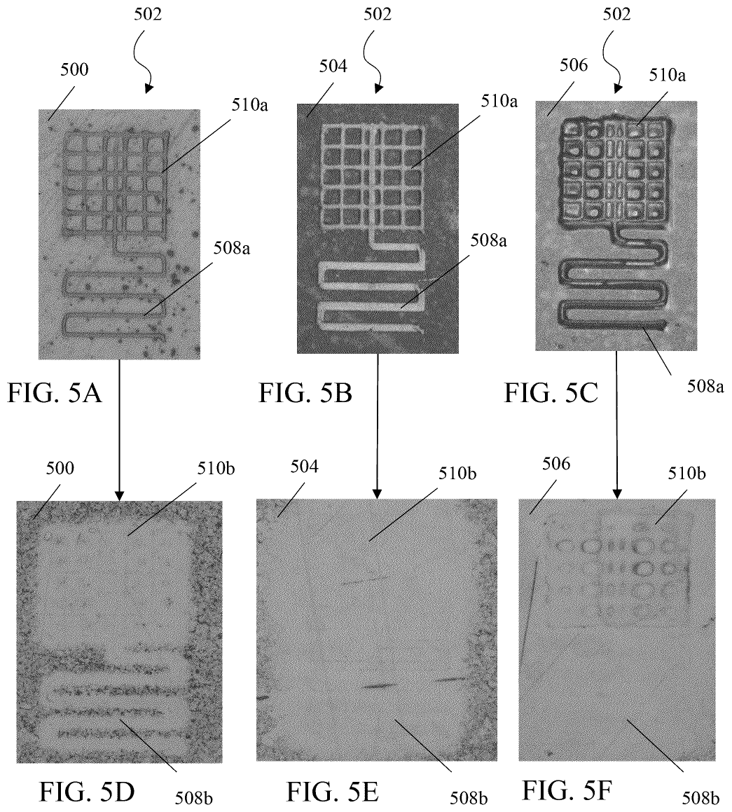

Referring to FIGS. 5A-5F, images of additive manufactured conductive structures 502 on substrates 500, 504, 506 before (5A-5C) and after (5D-5F) a removal procedure. The structures 502 were additively manufactured to include a serpentine line 508a and a mesh pad 510a.

Referring to FIGS. 5D-5F, the substrates 500, 504, 506 are shown following a removal procedure. The removal image depicts the substrate 500 following the removal procedure showing the removed serpentine lines 508b and the removed mesh pads 510b.

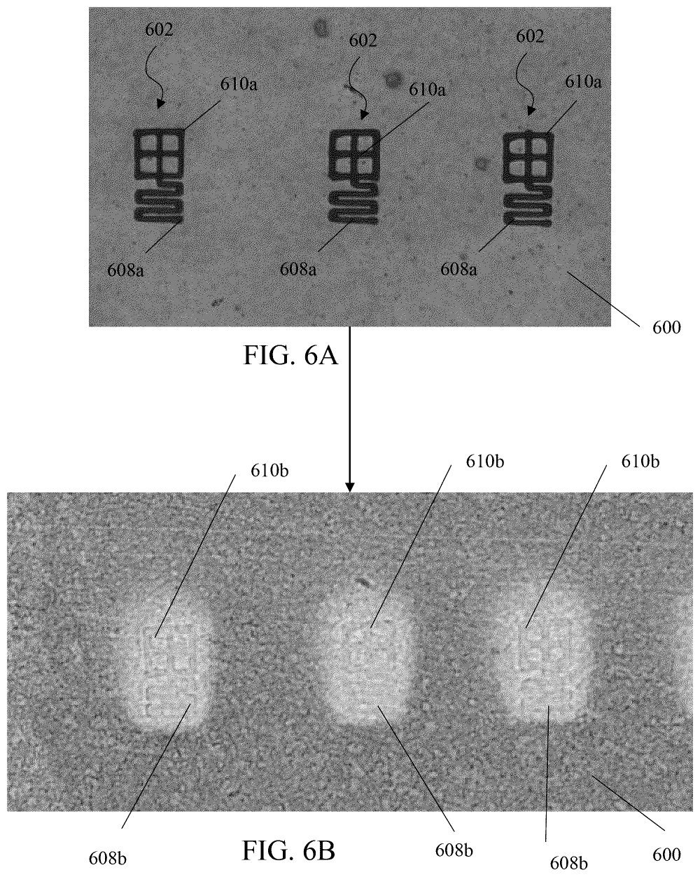

Referring to FIGS. 6A and 6B, a images of additive manufactured conductive structures 602 on a substrate 600 before (FIG. 6A) and after (FIG. 6B) a removal procedure. The structures 602 were additively manufactured to include a serpentine line 608a and a mesh pad 610a.

Referring to FIG. 6B, the substrate 600 is shown following a removal procedure. The removal image depicts the substrate 600 following the removal procedure showing the removed serpentine line 608b and the removed mesh pad 610b.

As used herein, the terms “on,” “dispensed over,” “dispensed onto,” “formed over,” “formed onto,” “deposited over,” “deposited onto,” “overlay,” “provided over,” “provided onto,” and the like, mean formed, overlaid, dispensed, deposited, or provided on but not necessarily in contact with the surface. For example, a composition “deposited onto” a substrate surface does not preclude the presence of one or more layers of the same or different composition located between the composition and the substrate.

Various aspects of the present disclosure include, but are not limited to, the aspects listed in the following numbered clauses.

Clause 1. A method comprising: additively manufacturing a conductive structure on a substrate; sintering the conductive structure; performing a manufacturing process with the conductive structure; and removing the conductive structure from the substrate.

Clause 2. The method of clause 1, wherein the manufacturing process comprises applying a mask to the substrate using the conductive structure, electrodeposition, electroplating using the conductive structure, or a combination thereof.

Clause 3. The method of any of clauses 1-2, wherein removing the conductive structure from the substrate comprises a wet method, laser ablation, applying a resin to the conductive structure and peeling the resin off, plasma treatment, or a combination thereof.

Clause 4. The method of any of clauses 1-3, wherein removing the conductive structure from the substrate comprise the wet method and the wet method comprises: contacting the conductive structure with a solution for a time period in a range of 1 minute to 24 hours, wherein the solution is at a temperature in a range of 10° C. to 120° C.

Clause 5. The method of clause 4, wherein the wet method further comprises: applying ultrasonic vibrations to the conductive structure.

Clause 6. The method of clause 3, wherein removing the conductive structure from the substrate comprise the wet method and the wet method comprises: contacting the conductive structure with a solution for a time period in a range of 10 minutes to 2 hours, wherein the solution is at a temperature in a range of 90° C. to 110° C.

Clause 7. The method of clause 6, wherein the wet method further comprises: applying ultrasonic vibrations to the conductive structure for a time period in a range of 1 minute to 24 hours at a temperature in a range of 10° C. to 120° C.; and/or applying ultrasonic vibrations to the conductive structure for a time period in a range of 5 minutes to 1 hour at a temperature in a range of 40° C. to 65° C.

Clause 8. The method of any of clauses 4-7, wherein the solution comprises a solvent.

Clause 9. The method of clause 8, wherein the solvent comprises water, an alcohol, acetone, or a combination thereof.

Clause 10. The method of any of clauses 8-9, wherein the solution further comprises a salt.

Clause 11. The method of clause 10, wherein the salt comprises a chloride salt, a bromide salt, or a combination thereof.

Clause 12. The method of clause 10, wherein the salt comprises sodium chloride.

Clause 13. The method of any of clauses 1-12, wherein removing the conductive structure from the substrate does not substantially etch the substrate, does not substantially corrode the substrate, or a combination thereof.

Clause 14. The method of any of clauses 1-13, wherein sintering the structure comprises heating the structure at a temperature in a range of 20° C. to 250° C. for a time period in a range of 1 minute to 8 hours.

Clause 15. The method of any of clauses 1-14, wherein sintering the structure comprises heating the structure to a temperature in a range of 180° C. to 220° C. for a time period in a range of 5 minutes to 1 hour.

Clause 16. The method of any of clauses 1-15, wherein sintering the structure comprises heating the structure to a temperature in a range of 100° C. to 150° C. for a time period in a range of 5 minutes to 1 hour.

Clause 17. The method of any of clauses 1-16, wherein sintering the structure comprises heating the structure to a temperature in a range of 80° C. to 120° C. for a time period in a range of 5 minutes to 1 hour.

Clause 18. The method of any of clauses 1-17, further comprising cleaning the substrate by performing at least one of the following: washing the substrate with a solvent; drying the substrate with a gas; and wiping the substrate with a cloth.

Clause 19. The method of clause 18, wherein the solvent comprises water, acetone, an alcohol, or a combination thereof.

Clause 20. The method of any of clauses 18-19, wherein the gas comprises nitrogen.

Clause 21. The method of any of clauses 18-20, wherein the cloth is dust-free.

Clause 22. The method of any of clauses 1-21, wherein the structure comprises a metal or a metal alloy.

Clause 23. The method of any of clauses 1-22, wherein the structure comprises silver.

Clause 24. The method of any of clauses 1-23, wherein the structure comprises a line, a solid pad, a mesh pad, or a combination thereof.

Clause 25. The method of any of clauses 1-24, wherein the structure comprises a serpentine line.

Clause 26. The method of any of clauses 1-25, wherein the substrate comprises a metal, a metal alloy, a polymer, or a combination thereof.

Clause 27. The method of any of clauses 1-26, wherein the substrate comprises copper, a copper alloy, a polymer, or a combination thereof.

Clause 28. The method of any of clauses 1-27, wherein the structure comprises 1 to 10 layers.

Clause 29. The method of any of clauses 1-28, wherein the structure comprises 1 to 5 layers.

Clause 30. The method of any of clauses 1-29, wherein the structure comprises a thickness in a range of 0.1 μm to 20 μm.

Clause 31. The method of any of clauses 1-30, wherein the structure comprises a thickness in a range of 1 μm to 5 μm.

Clause 32. The method of any of clauses 1-31, wherein additively manufacturing the conductive structure on the substrate comprises disposing a nozzle of a cartridge assembly of an additive manufacturing system over a first location on the substrate; dispensing an ink composition from the nozzle onto the first location of the substrate, thereby forming a first portion of the structure on the first location; and repeating, as necessary, repositioning of the nozzle and dispensing ink composition from the nozzle, thereby forming the structure on the substrate.

Clause 33. The method of clause 32, further comprising applying a pressure in a range of 100 mbar to 10,000 mbar to the ink composition in the nozzle to extrude the ink composition through the nozzle and onto the substrate.

Clause 34. The method of any of clauses 32-33, wherein the ink composition comprises a viscosity in a range of 100,000 cP to 10,000,000 cP as measured at 25 degrees Celsius with a rheometer with a 25 mm parallel plate spindle and a shear rate in a range of 0.1 s-1 to 100 s-1.

Clause 35. The method of any of clauses 32-34, wherein the nozzle comprises a capillary tube having an outer diameter in a range of 0.7 μm to 8 μm.

Clause 36. The method of any of clauses 1-35, wherein the conductive structure comprises a line having a width in a range of 0.1 μm to 50 μm.

Clause 37. The method of any of clauses 1-36, wherein sintering occurs in an inert atmosphere.

Clause 38. A method for removing a conductive structure from a substrate, the method comprising: contacting the conductive structure with a solution, wherein the solution is at a temperature in a range of 10° C. to 120° C. for a time period in a range of 1 minute to 24 hours.

Clause 39. The method of clause 38, further comprising: applying ultrasonic vibrations to the conductive structure.

Clause 40. The method of any of clauses 38-39, wherein the solution is at a temperature in a range of 90° C. to 110° C. and the time period is in a range of 10 minutes to 2 hours.

Clause 41. The method of any of clauses 38-40, further comprising: applying ultrasonic vibrations to the conductive structure at a temperature in a range of 10° C. to 120° C. for a time period in a range of 1 minute to 24 hours.

Clause 42. The method of any of clauses 38-41, further comprising: applying ultrasonic vibrations to the conductive structure at a temperature in a range of 40° C. to 65° C. for a time period in a range of 5 minutes to 1 hour.

Clause 43. The method of any of clauses 38-42, wherein the solution comprises a solvent.

Clause 44. The method of clause 43, wherein the solvent comprises water, an alcohol, acetone, or a combination thereof.

Clause 45. The method of clause 43, wherein the solution further comprises a salt.

Clause 46. The method of clause 45, wherein the salt comprises a chloride salt, a bromide salt, or a combination thereof.

Clause 47. The method of clause 45, wherein the salt comprises sodium chloride.

Clause 48. The method of any of clauses 38-47, wherein the method for removing the conductive structure from the substrate does not substantially etch the substrate, does not substantially corrode the substrate, or a combination thereof.

As used herein, a referenced element or region that is “intermediate” two other elements or regions means that the referenced element/region is disposed between, but is not necessarily in contact with, the two other elements/regions. Accordingly, for example, a referenced element that is “intermediate” a first element and a second element may or may not be immediately adjacent to or in contact with the first and/or second elements, and other elements may be disposed between the referenced element and the first and/or second elements.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited.

The grammatical articles “a,” “an,” and “the,” as used herein, are intended to include “at least one” or “one or more,” unless otherwise indicated, even if “at least one” or “one or more” is expressly used in certain instances. Thus, the articles are used herein to refer to one or more than one (i.e., to “at least one”) of the grammatical objects of the article. Further, the use of a singular noun includes the plural, and the use of a plural noun includes the singular, unless the context of the usage requires otherwise.

Any patent, publication, or other disclosure material identified herein is incorporated by reference into this specification in its entirety unless otherwise indicated, but only to the extent that the incorporated material does not conflict with existing descriptions, definitions, statements, or other disclosure material expressly set forth in this specification. As such, and to the extent necessary, the express disclosure material as set forth in this specification supersedes any conflicting material incorporated by reference. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicants reserve the right to amend this specification to expressly recite any subject matter, or portion thereof, incorporated by reference herein.

One skilled in the art will recognize that the herein described components (e.g., operations), devices, and objects, as well as the discussion accompanying them, are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

One skilled in the art will recognize that the herein-described components, devices, operations/actions, and objects, as well as the discussion accompanying them, are used as examples for the sake of conceptual clarity and that various configuration modifications are contemplated. Consequently, as used herein, the specific examples/embodiments set forth and the accompanying discussions are intended to be representative of their more general classes. In general, use of any specific exemplar is intended to be representative of its class, and the non-inclusion of specific components, devices, operations/actions, and objects should not be taken as limiting. While the present disclosure provides descriptions of various specific aspects for the purpose of illustrating various aspects of the present disclosure and/or its potential applications, it is understood that variations and modifications will occur to those skilled in the art. Accordingly, the present disclosure should be understood to be at least as broad as it is claimed and not as more narrowly defined by particular illustrative aspects provided herein.

What is claimed is:

1. A method comprising:
additively manufacturing a conductive structure on a substrate;
sintering the conductive structure;
performing a manufacturing process with the conductive structure; and
removing the conductive structure from the substrate.

2. The method of claim 1, wherein the manufacturing process comprises applying a mask to the substrate using the conductive structure, electrodeposition, electroplating using the conductive structure, or a combination thereof.

3. The method of claim 1, wherein removing the conductive structure from the substrate comprises a wet method, laser ablation, applying a resin to the conductive structure and peeling the resin off, plasma treatment, or a combination thereof.

4. The method of claim 3, wherein removing the conductive structure from the substrate comprise the wet method and the wet method comprises:
contacting the conductive structure with a solution for a time period in a range of 1 minute to 24 hours, wherein the solution is at a temperature in a range of 10° C. to 120° C.

5. The method of claim 4, wherein the wet method further comprises:
applying ultrasonic vibrations to the conductive structure.

6. The method of claim 3, wherein removing the conductive structure from the substrate comprise the wet method and the wet method comprises:
contacting the conductive structure with a solution for a time period in a range of 10 minutes to 2 hours, wherein the solution is at a temperature in a range of 90° C. to 110° C.

7. The method of claim 6, wherein the wet method further comprises:
applying ultrasonic vibrations to the conductive structure for a time period in a range of 1 minute to 24 hours at a temperature in a range of 10° C. to 120° C.; and/or
applying ultrasonic vibrations to the conductive structure for a time period in a range of 5 minutes to 1 hour at a temperature in a range of 40° C. to 65° C.

8. The method of claim 1, wherein sintering the structure comprises heating the conductive structure at a temperature in a range of 20° C. to 250° C. for a time period in a range of 1 minute to 8 hours.

9. The method of claim 1, wherein sintering the structure comprises heating the conductive structure to a temperature in a range of:
180° C. to 220° C.;
100° C. to 150° C.; or
80° C. to 120° C.,
wherein the heating is performed for a time period in a range of 5 minutes to 1 hour.

10. The method of claim 1, wherein the conductive structure comprises a metal or a metal alloy and the substrate comprises a metal, a metal alloy, a polymer, or a combination thereof.

11. The method of claim 1, wherein the conductive structure comprises silver and the substrate comprises copper, a copper alloy, a polymer, or a combination thereof.

12. The method of claim 1, wherein the conductive structure comprises a serpentine line.

13. The method of claim 1, wherein the conductive structure comprises a thickness in a range of 0.1 μm to 20 μm.

14. A method for removing a conductive structure from a substrate, the method comprising:
contacting the conductive structure with a solution, wherein the solution is at a temperature in a range of 10° C. to 120° C. for a time period in a range of 1 minute to 24 hours.

15. The method of claim 14, further comprising:
applying ultrasonic vibrations to the conductive structure at a temperature in a range of 10° C. to 120° C. for a time period in a range of 1 minute to 24 hours.

16. The method of claim 14, wherein the solution is at a temperature in a range of 90° C. to 110° C. and the time period is in a range of 10 minutes to 2 hours.

17. The method of claim 14, wherein the solution comprises a solvent comprising water, an alcohol, acetone, or a combination thereof.

18. The method of claim 17, wherein the solution further comprises a salt comprising a chloride salt, a bromide salt, or a combination thereof.

19. The method of claim 18, wherein the salt comprises sodium chloride.

20. The method of claim 14, wherein the method for removing the conductive structure from the substrate does not substantially etch the substrate, does not substantially corrode the substrate, or a combination thereof.
